(19) United States
(12) Patent Application Publication
(10) Pub. No.: US 2015/0323919 A1
(43) Pub. Date: Nov. 12, 2015

(54) METHOD FOR OPERATING A CONTROL UNIT

(71) Applicant: Robert Bosch GmbH, Stuttgart (DE)

(72) Inventors: Thorsten Schwepp, Korb (DE); Markus Ihle, Hemmingen (DE); Andreas Soenkens, Remseck Am Neckar (DE); Thomas Kuhn, Heilbronn (DE); Stefan Schneider, Moensheim (DE)

(21) Appl. No.: 14/703,276

(22) Filed: May 4, 2015

(30) Foreign Application Priority Data
May 12, 2014 (DE) 10 2014 208 853.4

(51) Int. Cl. G05B 19/048

(52) U.S. Cl. CPC G05B 19/048; G05B 2219/2623; G05B 2219/24015

(57) ABSTRACT

In a method for operating a control unit using an electronic hardware security module, a secure layer is provided, which is assigned to the hardware security module and monitors the operation of the main computer unit. The secure layer switches to an operation under emergency conditions if a malfunction is present.

### BACKGROUND OF THE INVENTION

1. Field of the Invention

The present invention relates to a control unit and a method for operating such a control unit, which control unit is used in a motor vehicle for an internal combustion engine.

2. Description of the Related Art

Control units are electronic modules which, for instance, are used in motor vehicles for the control and regulation of functional sequences. For this purpose the control units are assigned to the particular components of the motor vehicle whose operation will be controlled with the aid of the assigned control unit. In order to do so, the control unit reads in data acquired by sensors and influences the operation by controlling actuators.

The described method is used in conjunction with an electronic security module, which is utilized in a control unit, especially in the automotive field, in security-relevant areas. The manipulation-proof or non-monitorable storing of data is an essential requirement in most applications in the security-relevant areas. Cryptographic keys, which are utilized in symmetrical or asymmetrical encryption methods, are used for this purpose.

The employed codes and encryption methods constitute secrets that need to be kept hidden from attackers. Other uses in security-relevant areas, for instance, concern the protection against unauthorized modifications, such as the storing of changed serial numbers or odometer readings, the prevention of unauthorized tuning measures, etc.

Hence it is necessary to provide secure environments in control units, in which functionalities that must have access to and/or modify these secrets can be executed. These environments usually have a secure computer unit or CPU, also referred to as secure CPU, as well as a storage module. An environment of this type is called a hardware security module (HSM) in this document. It represents a high-performance module which includes hardware and software components and improves the security and trustworthiness of embedded systems. The HSM in particular helps in protecting security-critical applications and data. The security costs are also able to be reduced by an HSM, while effective protection against attackers is offered at the same time. As far as the basic structure of an HSM is concerned, reference is made to FIG. 3.

It is known to use more than one control unit in motor vehicles for the actuation of certain components, such as the actuation of the internal combustion engine provided for the driving. As a result, it is possible that a control unit and another control unit are provided, which jointly actuate the internal combustion engine. It must be taken into account here that if one of the two control units fails or malfunctions, the correct operation of the internal combustion engine may possibly no longer be ensured.

One method for operating a control unit for an internal combustion engine is known from the published German patent application document DE 10 2011 08 87 64 A1. In the method, the control unit actuates the internal combustion engine in a first operating mode jointly with at least another control unit. The control unit is meant to monitor the at least one further control unit for a malfunction, and if a malfunction has occurred, to switch from the first operating mode to a second operating mode, in which the control unit is able to maintain an operation of the internal combustion engine independently of the at least one further control unit. As a result, a reliable operation of the internal combustion engine can be ensured even if malfunctions are present.

### BRIEF SUMMARY OF THE INVENTION

The use of the introduced method makes it possible to ensure an operation under emergency conditions in the affected control unit even without the main computer unit. All inputs and outputs of the affected control unit are still able to be actuated. In addition, all main computer units can be switched off completely if a manipulation is detected, for instance.

The basis of the introduced method is that the HSM security layer has the ability to switch between different operations under emergency conditions programs. In the process, the HSM switches the input and output terminals, or I/O pins, to external communications interfaces or to an internal operation under emergency conditions program.

Thus, the fact is utilized that the HSM security layer has the capability of switching between different operations under emergency conditions programs. Different operations under emergency conditions options, i.e., externally and internally, are listed hereinafter:

1. Operation under emergency conditions externally
a. The HSM deactivates the main computer unit or main computer,
b. The HSM switches input/output modules to an external communications interface,
c. The operation of the input/output modules now takes place via the control unit on which the operation under emergency conditions program is active,
d. The communication may take place via a conventional or a secure interface.
2. Operation under emergency conditions internally
a. The HSM deactivates the main computer unit,
b. The HSM switches the I/O modules to the internal operation under emergency conditions program in the HSM.
3. An operation under emergency conditions is possible in a mixed operation made up of external and internal.
4. If sufficient resources, e.g., with regard to RAM, flash and runtime, are available in the external control unit-HSM, it is also possible to store a redundant program there, i.e., the same program as on the main computer unit, and to execute it in an emergency.

Additional advantages and developments of the present invention derive from the specification and the appended drawing.

It is understood that the features mentioned above and the features yet to be described may be used not only in the individually given combination but in other combinations or in isolation as well, without departing from the scope of the present invention.

### BRIEF DESCRIPTION OF THE DRAWINGS

FIG. 1 shows a trust pyramid.

FIG. 2 shows functionalities of an HSM in a schematic representation.

FIG. 3 shows the structure of one specific embodiment of the HSM in a schematic representation.

FIG. 4 shows a specific embodiment of a control unit.

FIG. 5 shows possible specific embodiments of the control unit.

### DETAILED DESCRIPTION OF THE INVENTION

The present invention is represented schematically in the drawing on the basis of specific embodiments and described in the following text with reference to the drawing.

To trust an IT system that it will always act as expected requires trust in all of the incorporated layers, one after the other, in order to create a trustworthy IT system.

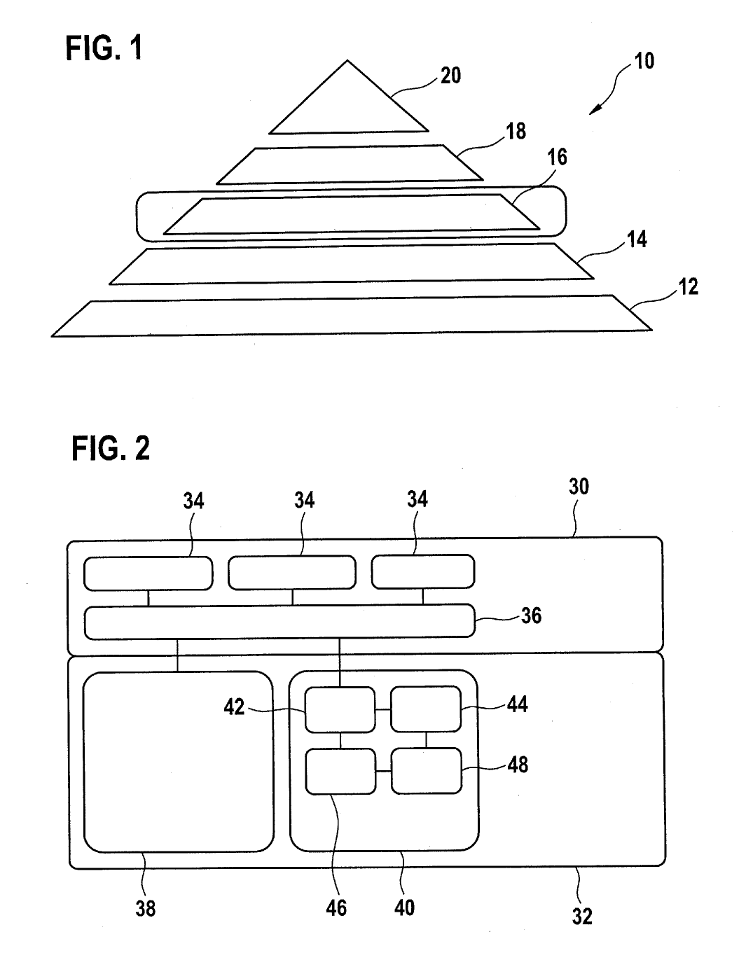

FIG. 1 shows a trust pyramid for a typical IT system. It is provided with reference number 10 overall and includes one layer for organizational security 12, one layer for system security 14, one layer for hardware security 16, one layer for software security 18, and an uppermost layer for trust 20.

Trust in the entire IT system requires that each layer be able to rely on the effective security of the layer situated underneath, without having the ability to verify this fact independently. For example, this means that it is possible that a perfect software and hardware security solution may turn out to be useless because of a weak security system design situated underneath. Moreover, it may be the case that a potential weakness in the system design will not be detected or prevented by the upper hardware and software layers.

In contrast to typical back and IT systems, the hardware layer of embedded systems is frequently exposed to physical attacks that influence hardware or software functionalities through physical means, e.g., manipulate a flash memory or deactivate alarm functionalities. One particular approach for making such physical attacks more difficult is the use of manipulation-proof hardware security modules (HSM), such as those shown in FIG. 2, for instance. Such an HSM protects important information, for example personal identification numbers (PIN), secure keys and critical operations such as a PIN verification and data encryption, e.g., by strong physical shielding.

The manner in which an HSM may be developed and the kind of functionalities it is able to perform in order to improve the security of an embedded system will be shown in the following text.

FIG. 2 depicts the core functionalities of a typical hardware security module. The illustration shows a software layer 30 and a hardware layer 32, which is protected against unauthorized access.

Software layer 30 includes a number of applications 34, of which three are illustrated in this instance. An operating system 36 is provided in addition. Hardware layer 32 includes embedded standard hardware 38 and a hardware security module (HSM) 40. A first block 42 in this HSM 40 is provided for interfaces and the control, a second block 44 is provided for secure encryption functionalities, a third block 46 is provided for secure functionalities, and a secure memory 48 is included.

Secure memory 48 is a small, non-volatile data memory, e.g., having a capacity of a few kilobytes, within manipulation-proof HSM 40, so that an unauthorized readout or a manipulation or deletion of critical information, e.g., of cryptographic keys, cryptographic certificates or authentication data such as PINs or passwords, is prevented.

In addition, secure memory 48 of HSM 40 holds all HSM configuration information, such as information pertaining to the owner of HSM 40, or access authorizations to secure internal units.

Second block 44 for secure encryption functionalities holds cryptographic algorithms which are used for data encryption and decoding, such as AES or 3DES, data integrity amplification, such as MAC or HMAC, or a data origin verification, e.g., through the use of digital signature algorithms such as RSA or ECC, as well as all associated cryptographic activities, such as key generation and key verification, for instance.

Secure functionalities in third block 46 include all protected functionalities that are not directly assigned to a cryptographic method, HSM 40 serving as physically protected “trust anchor”. For example, this may be a physically protected clock signal, an internal random-number generator, a loading routine protection mechanism or some other critical application functionality, such as for realizing a secure dongle.

First block 42 for interfaces and the control includes the internal HSM logic, which implements the HSM communication with the external world and administers the operation of all internal basic components such as the ones previously mentioned.

All functional basic components of hardware security module 40, as described above, are surrounded by an uninterrupted physical boundary, which prevents internal data and processes from being monitored, copied or cloned or manipulated. This could enable an unauthorized user to use or compromise internal secrets. The cryptographic boundary is commonly implemented by algorithmic and physical time channel countermeasures with dedicated access protection means, such as special shielding or layers in order to enable side channel resistance, access reporting, access resistance or an access response, for instance.

The manner in which HSM 40 is able to improve the security of an embedded product solution will be elucidated in the following text.

HSM 40 protects critical information, e.g., identities, cipher keys or keys, with the aid of the physical shield that cannot be circumvented by software susceptibility.

HSM 40 is able to assist in detecting, weakening or deterring powerful POI attackers (POI=point of interest), by implementing effective side channel resistance and access protection barriers, which, among other things, have severe access restrictions that apply even to authorized users. For example, some information is always held within HSM 40 exclusively.

HSM 40 is able to accelerate security mechanisms in which certain acceleration switching circuits are utilized.

The use of HSM 40 makes it possible to reduce the security costs by adding highly optimized special switching circuits, for instance for standardized cryptography.

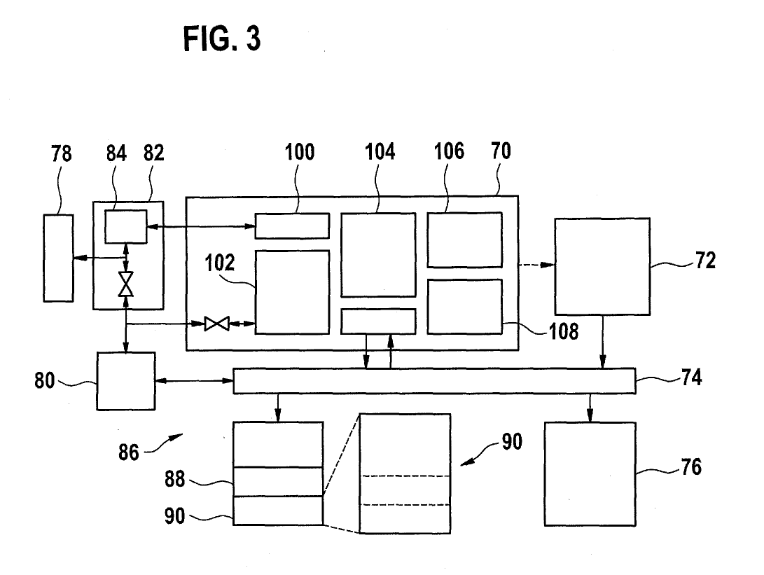

One possible structure of the HSM is shown in FIG. 3. It shows HSM 70, which is embedded in an environment. The figure depicts a main computer unit 72, a system bus 74, a RAM component 76 having an area for joint use, and a test program 78 or debugger including associated hardware 80 and interface 82, the latter in turn including a register 84. Moreover, the figure shows a memory component 86 for flash code having a data area 88 and a secure area 90, in which secure core data are contained.

Provided in HSM 70 are an interface 100 with respect to test program 78, a secure computer core 102, a secure RAM component 104, a random-number generator 106, e.g., a TRNG or PRNG, and a key 108, e.g., AES.

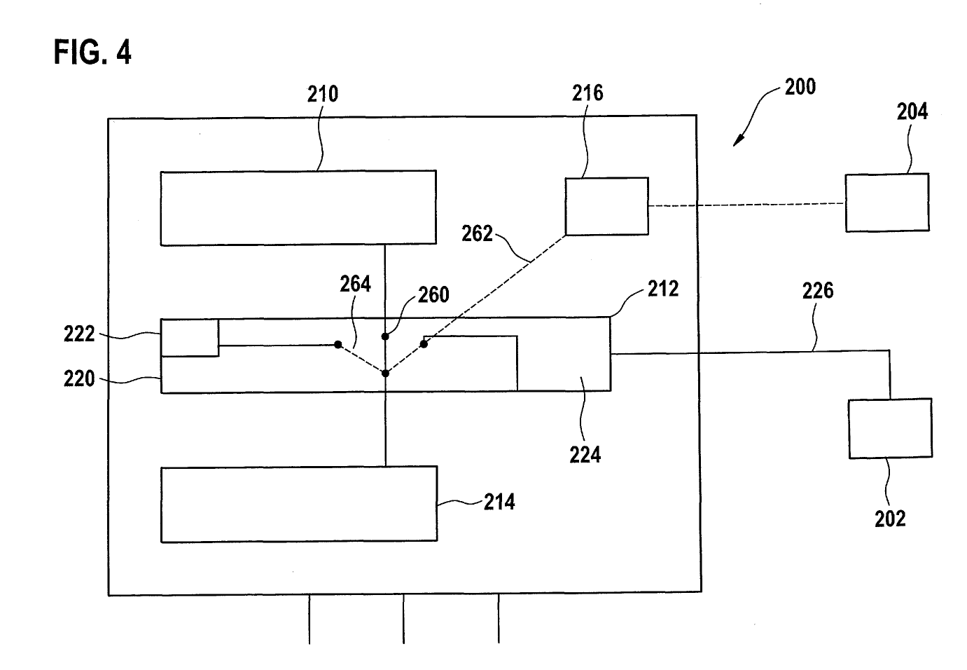

FIG. 4 shows a specific development of a control unit, which is denoted by reference numeral 200 overall. In addition, another control unit 202 and yet another control unit 204 are depicted. A main computer unit 210, an electronic hardware security module 212 and input/output modules 214 are provided in control unit 202. Moreover, a communications interface 216 is provided.

An operation under emergency conditions program 222 is stored in a secure layer 220 of HSM 212. A secure communications module 224 in HSM 212 connects HSM 212 via a secure HSM bus 226 to additional control unit 202. A first mode 260 indicates the normal state, in which a normal closed-loop operation takes place and main computer unit 210 accesses input/output modules 214 via HSM 212. A second mode 262 indicates an external operation under emergency conditions, in which communications interface 216 is accessed. Main computer unit 210 may also be deactivated in this case.

A third mode 264 indicates internal operation under emergency conditions, in which operation under emergency conditions program 222 is accessed.

Main computer unit 210 must always go via HSM 212 in order to obtain access to input/output modules 214. They are not directly connected to main computer unit 210. The layer situated in between is either HSM 212 itself or a software that is controlled by it.

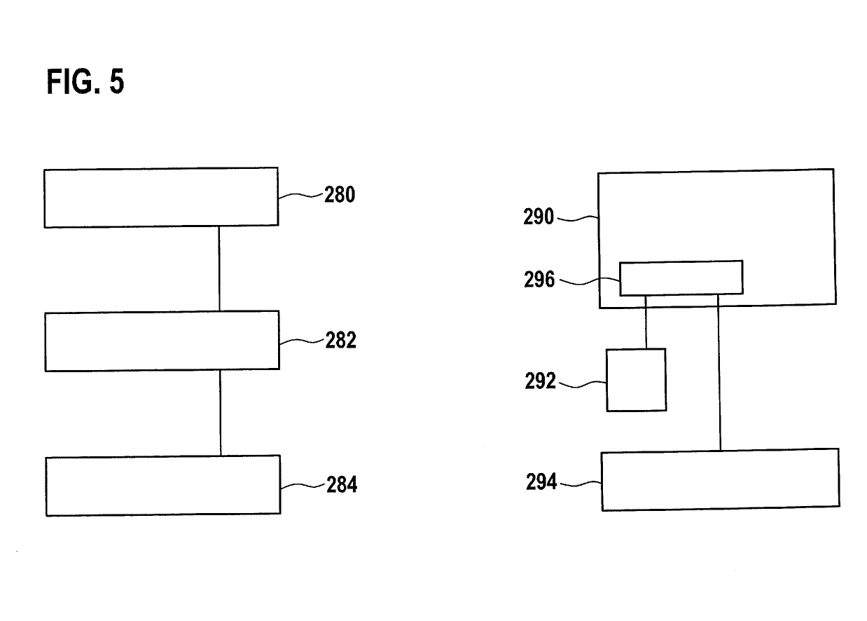

FIG. 5 shows possible specific embodiments of the control unit. A main computer unit 280, an HSM 282 and an input/output module 284 are shown on the left side. Main computer unit 280 accesses input/output module 284 via HSM 282.

A main computer unit 290, an HSM 292 and an input/output module 294 are also shown on the right side. A secure layer 296, typically a software layer, which is controlled by HSM 292 and therefore assigned to it, is provided in main computer unit 290. Access to input/output modules 294 takes place via this layer 296.

What is claimed is:

1. A method for operating a control unit which includes a main computer unit and an electronic hardware security module, comprising:
monitoring, by a secure layer which is assigned to the hardware security module, an operation of the main computer unit; and
switching the operation of the secure layer to an operation under emergency conditions if a malfunction exists.

2. The method as recited in claim 1, wherein the secure layer switches to an external operation under emergency conditions.

3. The method as recited in claim 2, wherein the secure layer deactivates the main computer unit and switches at least one input/output module to an external communications interface.

4. The method as recited in claim 1, wherein the secure layer switches to an internal operation under emergency conditions.

5. The method as recited in claim 4, wherein the secure layer deactivates the main computer unit and switches at least one input/output module to an internal operation under emergency conditions.

6. An electronic hardware security module of a control unit, comprising:
a secure layer configured to:
(i) monitor an operation of a main computer unit of the control unit; and
(ii) switch the operation of the secure layer to an operation under emergency conditions if a malfunction exists.

7. The electronic hardware security module as recited in claim 6, wherein the electronic hardware security module is (i) configured to switch to an internal operation under emergency conditions and (ii) includes an internal-operation-under-emergency-conditions program.

8. The electronic hardware security module as recited in claim 6, wherein the electronic hardware security module is configured to switch to an external operation under emergency conditions.

9. A control unit, comprising:
a main computer unit; and
an electronic hardware security module including a secure layer configured to:
(i) monitor an operation of the main computer unit; and
(ii) switch the operation of the secure layer to an operation under emergency conditions if a malfunction exists.
